(19) United States
(12) Patent Application Publication
(10) Pub. No.: US 2021/0364630 A1
(43) Pub. Date: Nov. 25, 2021

(54) INSTALLATION STATE DIAGNOSING DEVICE, INSTALLATION STATE DIAGNOSING METHOD AND PROGRAM THEREFOR, AND INSTALLATION STATE DISPLAY METHOD

(71) Applicant: NIPPON TELEGRAPH AND TELEPHONE CORPORATION, Tokyo (JP)

(72) Inventors: Tetsuya IWADO, Musashino-shi, Tokyo (JP); Yoshiyuki KAJIHARA, Musashino-shi, Tokyo (JP); Ryuji HONDA, Musashino-shi, Tokyo (JP)

(73) Assignee: NIPPON TELEGRAPH AND TELEPHONE CORPORATION, Tokyo (JP)

(21) Appl. No.: 16/979,562

(22) PCT Filed: Mar. 7, 2019
(86) PCT No.: PCT/JP2019/009143

§ 371 Date: Sep. 10, 2020

(30) Foreign Application Priority Data
Mar. 12, 2018 (JP) 2018-044771

(51) Int. Cl. G01S 13/89; H02G 1/02

(52) U.S. Cl. CPC G01S 13/89; H02G 1/02

(57) ABSTRACT

An embodiment of the present invention is an equipment state diagnosis device including a classification unit that classifies an equipment state of a utility pole into an equipment configuration pattern based on equipment configuration information of the utility pole obtained from a database in which the equipment configuration information and a deflection amount of the utility pole are stored, and a diagnosis method determination unit that determines a diagnosis method for the utility pole from the equipment configuration pattern of the utility pole classified by the classification unit and the deflection amount of the utility pole obtained from the database.

### TECHNICAL FIELD

The present invention relates to an equipment state diagnosis device for detecting a state of equipment of a columnar object that is a management target mainly installed at an outdoor place such as a utility pole or a signal pole, an equipment state diagnosis method, a program thereof, and an equipment state display method.

### BACKGROUND ART

When equipment that is a management target is a utility pole, a plurality of cables are strung from many directions on the utility pole, and tension is applied to each of the cables. When balance of tension is not maintained, a balanced state is maintained by handling such as installation of a branch line. However, there are also unbalanced utility poles due to the fact that no branch line is installed despite a need for the branch line. Further, it is believed that an unbalanced utility pole is deflected by an unbalanced load.

Because inspection of utility poles in the related art is visually performed, it is not possible to quantitatively measure deflection of the utility poles. Accordingly, a worker visually confirms an equipment configuration and looks for an unbalanced utility pole.

On the other hand, a mobile mapping system (MMS) that ascertains a three-dimensional shape of outdoor structures is known (see, for example, NPL 1). This system is a system in which a three-dimensional laser scanner (a 3D laser surveying instrument), a camera, a GPS device, an inertial measurement unit (IMU), and an odometer (a travel distance meter) are mounted in an inspection vehicle. In the system, the inspection vehicle comprehensively performs three-dimensional surveying of an outdoor structure including nearby buildings, roads, bridges, or the like while traveling on a roadway, and collects three-dimensional coordinates of a large number of points on a surface of the outdoor structure to ascertain a three-dimensional shape of the outdoor structure. The system acquires absolute three-dimensional coordinates of points irradiated with laser light that is applied to the surface of the outdoor structure as point cloud data (hereinafter, point cloud data). When the number of irradiation points is larger, a more accurate three-dimensional shape can be reproduced.

A method of generating three-dimensional data of an object from point cloud data obtained using the MMS and detecting a state of equipment from this three-dimensional data is known (see, for example, PTL 1). With this method, it is possible to generate three-dimensional data of the object and accurately measure data regarding a shape of the object, such as a shape such as a slope of a center axis and deflection of a utility pole. Further, this measurement data can be registered in an equipment management database for each of utility poles.

In current inspection, a worker looks for an unbalanced utility pole from an equipment configuration. But deflection can be directly measured using an MMS, and thus, it is conceivable that utility poles needing to be handled can be narrowed down using only a deflection value (see, for example, NPL 2).

### CITATION LIST

### Patent Literature

PTL 1: Japanese Unexamined Patent Application Publication No. 2015-078849 A

### Non Patent Literature

NPL 1: “Mitsubishi Mobile Mapping System and High Precision GPS Movable Measurement device”, [online], July 2013, Mitsubishi Electric Co., Ltd., [Retrieved on Sep. 24, 2013], Internet <URL: http://www.mitsubishielectric.co.jp/mms/>
NPL 2: “Technology Development for Innovation of Access Equipment Operation”, February 2017, NTT Technology Development journal, [Retrieved on Feb. 13, 2018], Internet <URL: http://www.ntt.co.jp/journal/1702/files/jn20170251.pdf#search=%27%E3%81%9F%E3%82%8F%E3%81%BF+%E9%9B%BB%E6%9F%B1+%EF%BC%AE%EF%BC%B4%EF%BC%B4%27>

### SUMMARY OF THE INVENTION

### Technical Problem

However, in fact, there is a utility pole that is deflected despite the utility pole being balanced with respect to an equipment configuration or a utility pole that is not deflected despite the utility pole being unbalanced with respect to an equipment configuration. Thus, when the state of the utility pole is evaluated on the basis of only the equipment configuration information or the deflection, there is concern that appropriate handling cannot be performed.

The present invention has been made in view of the aforementioned circumstances, and an object of the present invention is to provide an equipment state diagnosis device, an equipment state diagnosis method, a program thereof, and an equipment state display method capable of diagnosing an equipment state of a columnar object that is a management target, which cannot be determined on the basis of only equipment configuration information or a deflection amount of the columnar object.

### Means for Solving the Problem

A first aspect of the present invention is an equipment state diagnosis device including: a classification unit that classifies an equipment state of a utility pole into an equipment configuration pattern based on equipment configuration information of the utility pole obtained from a database in which the equipment configuration information and a deflection amount of the utility pole are stored; and a diagnosis method determination unit that determines a diagnosis method for the utility pole from the equipment configuration pattern of the utility pole classified by the classification unit and the deflection amount of the utility pole obtained from the database.

According to the first aspect, the equipment configuration information of the utility pole can be classified into the equipment configuration patterns on the basis of the equipment configuration information of the utility pole, and the diagnosis method of the utility pole can be determined while taking both the classified patterns and the deflection amount of the utility pole into consideration, thus, it is possible to accurately determine the diagnosis method even for equipment states that would be overlooked with only the equipment configuration information or only the deflection amount of the utility pole.

A second aspect is the first aspect further including: a display control unit that generates display data for causing a terminal to display the diagnosis method for the utility pole determined by the diagnosis method determination unit.

According to the second aspect, the display data for displaying the determined diagnosis method is generated, and thus a user can confirm the diagnosis method for the utility pole.

A third aspect is the second invention, wherein the display data generated by the display control unit is data for causing the diagnosis method determined by the diagnosis method determination unit for the utility pole to be displayed on a map.

According to the third aspect, the diagnosis method for the utility pole can be displayed on the map, and thus a worker can visually determine an area to be diagnosed preferentially.

A fourth aspect is the third invention, wherein the diagnosis method determination unit includes a score calculation unit that calculates a score of the diagnosis method determined by the diagnosis method determination unit, and the display data generated by the display control unit is data for causing the diagnosis method for the utility pole to be displayed on a map in a display aspect according to the score calculated by the score calculation unit.

According to the fourth aspect, importance of the diagnosis method can be determined according to the score even when the diagnosis methods are the same, and thus it is possible to perform measures on equipment preferentially from equipment with the worst symptom.

A fifth aspect is the second aspect wherein the display data generated by the display control unit is data for causing line information on lines between utility poles to be displayed on a map based on the equipment configuration information.

According to the fifth aspect, the line information on lines between the utility poles can be displayed on the map, in addition to the diagnosis method, and thus it is possible to ascertain an equipment situation of all lines affecting each other rather than a utility pole alone, and adopt measures taking optimization of all the lines into account.

A sixth aspect is the first aspect, wherein the equipment configuration information includes position coordinates, support line information, connection destination utility pole information, branch line information, and projecting hardware information of the utility pole, and the classification unit classifies the equipment configuration patterns of the utility pole based on the position coordinates, the support line information, the connection destination utility pole information, the branch line information, and the projecting hardware information of the utility pole.

According to the sixth aspect, the equipment configuration patterns can be classified on the basis of various types of information of the utility pole (the position coordinates, the support line information, the connection destination utility pole information, the branch line information, and the projecting hardware information of the utility pole), and thus it is possible to reduce an operation for classification work as compared with manual work, in addition to the effects of the first invention.

The seventh aspect is an equipment state diagnosis method including: classifying an equipment states of a utility pole into an equipment configuration pattern based on equipment configuration information of the utility pole obtained from a database in which the equipment configuration information and a deflection amount of the utility pole are stored; and determining a diagnosis method for the utility pole from the equipment configuration pattern classified of the utility pole and the deflection amount of the utility pole obtained from the database.

An eighth aspect is a program for causing a computer to execute the equipment state diagnosis method of the seventh aspect.

According to the seventh and eighth aspects, it is possible to accurately determine the diagnosis method even for equipment states that would be overlooked with only the equipment configuration information or only the deflection amount of the utility pole, similar to the first aspect.

A ninth aspect is an equipment state display method including: classifying an equipment state of a utility pole into an equipment configuration pattern based on equipment configuration information of the utility pole, and receiving display data comprising a diagnosis method for the utility pole diagnosed from the classified equipment configuration patterns of the utility pole and a deflection amount of the utility pole, and another diagnosis method for another utility pole; and displaying the received display data, the diagnosis method for the utility pole and the another diagnosis method for the another utility pole on a map as visualization graphs divided for each of the diagnosis method and the another diagnosis method together with line information of the utility pole and the another utility pole.

According to the ninth aspect, the utility pole diagnosis method is displayed as a visualization graph on the map together with the line information of the utility pole and other utility poles, and thus a user can ascertain an equipment situation of all lines affecting each other rather than a utility pole alone, and adopt measures taking optimization of all the line into account.

### Effects of the Invention

According to the present invention, it is possible to diagnose an equipment state of a management target columnar object that cannot be diagnosed with only equipment configuration information or only a deflection amount of the columnar object.

### BRIEF DESCRIPTION OF DRAWINGS

FIG. 1 is a diagram illustrating an example of an equipment state diagnosis system S according to an embodiment of the present invention.

FIG. 2 is a diagram illustrating an example of an MMS 1 that acquires measurement data (point cloud data or image data).

FIG. 3 is a diagram illustrating an example of equipment data that is stored in an equipment database 5.

FIG. 4 is a flowchart illustrating an example of an operation of a server 3 of the equipment state diagnosis system S.

FIG. 5 is a diagram illustrating an example of an equipment state of a target utility pole A.

FIG. 6 is a diagram illustrating an example of a cable pair #1 of the target utility pole A.

FIG. 7 is a diagram illustrating an example of cable pairs #2 and #3 of the target utility pole A.

FIG. 8A is a flowchart illustrating an example of an operation for classifying equipment configuration patterns.

FIG. 8B is a flowchart illustrating an example of an operation for classifying equipment configuration patterns.

FIG. 9A is a diagram illustrating a case in which a cable pair #1 illustrated in FIG. 6 is determined to be an equipment configuration pattern I (an intermediate pole).

FIG. 9B is a diagram illustrating a case in which the cable pair #1 illustrated in FIG. 6 is determined to be the equipment configuration pattern I (an intermediate pole).

FIG. 10A is a diagram illustrating a case in which a cable pair #2 illustrated in FIG. 7 is determined to be an equipment configuration pattern B.

FIG. 10B is a diagram illustrating a case in which the cable pair #2 illustrated in FIG. 7 is determined to be the equipment configuration pattern B.

FIG. 11 is a diagram illustrating an example of a method of determining whether there is an intermediate branch.

FIG. 12 is a diagram illustrating an example of a diagnosis scheme that is determined through quadrant classification.

FIG. 13 is a diagram illustrating an example of a method of determining a quadrant score on the basis of a deflection amount and a degree of imbalance.

FIG. 14 is a diagram illustrating an example of a correspondence between a quadrant score and a color bar.

FIG. 15 is a diagram illustrating an example of a screen in which a heat map and line information to be displayed on the user terminal 2-2 are displayed on a map by display data generated by a heat map generation unit 3-2-3.

FIG. 16 is a diagram illustrating a modification example of a screen in which a deflection heat map and an imbalance heat map are displayed in a superimposed state on a map.

### DESCRIPTION OF EMBODIMENTS

Hereinafter, an equipment state diagnosis system for a utility pole according to an embodiment of the present disclosure will be described with reference to the drawings. Although utility poles will be described in the embodiment, the present invention is not limited to the utility poles and equipment serving as a management target may be a columnar object.

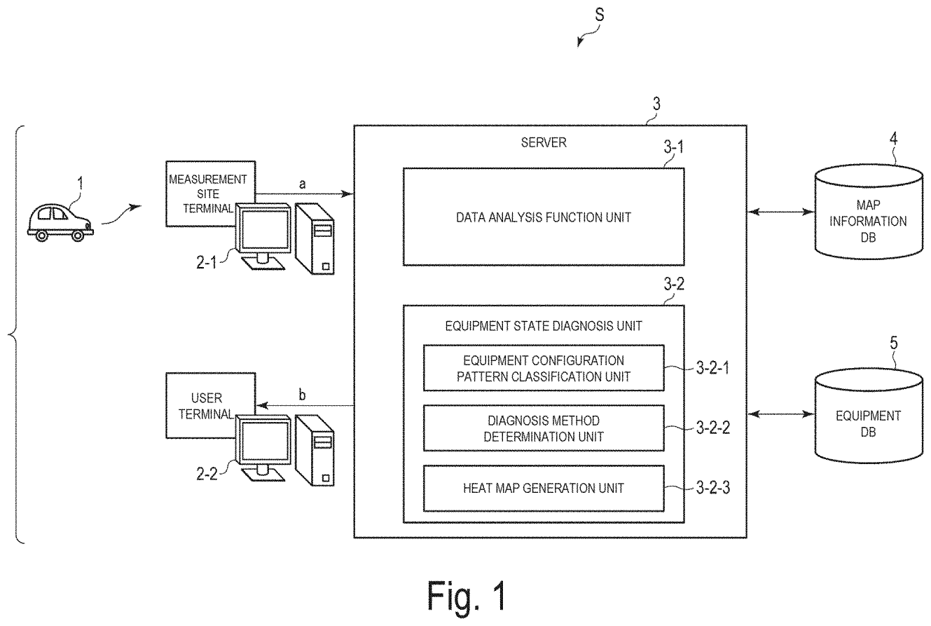

FIG. 1 is a diagram illustrating an example of an equipment state diagnosis system S according to an embodiment of the present invention.

As illustrated in the same drawing, the equipment state diagnosis system S includes an MMS 1, a measurement site terminal 2-1, a server 3, a map information database (DB) 4, and an equipment database 5.

The MMS 1 acquires measurement data including point cloud data, which is represented by three-dimensional position coordinates (X, Y, Z), image data, and the like. The measurement site terminal 2-1 acquires the measurement data from the MMS 1. The server 3 is connected to the measurement site terminal 2-1 and a user terminal 2-2 via a network, analyzes the measurement data from the measurement site terminal 2-1, and transmits display data for displaying a heat map indicating a state of the equipment to the user terminal 2-2. The map information database 4 and the equipment database 5 are connected to the server 3 via the network. The measurement site terminal 2-1 and the user terminal 2-2 are, for example, personal computers or the like. The arrow a in FIG. 1 indicates an input of the measurement data, and the arrow b in FIG. 1 indicates an output of the display data.

The server 3 can be configured as a computer including a central processing unit (CPU), a program memory, an operation memory, a mass storage device, and the like. The server 3 includes a data analysis function unit 3-1 and an equipment state diagnosis unit 3-2 as functions necessary to implement this embodiment.

The data analysis function unit 3-1 and the equipment state diagnosis unit 3-2 can be realized by causing the CPU to execute a program stored in the program memory. The map information database 4 and the equipment database 5 can be realized by a storage device such as a non-volatile memory.

The server 3 can be configured using hardware, but can be realized by, for example, a combination of a known computer in which a program including a procedure shown in a flowchart to be described below is installed via a medium or a communication line, the map information database 4, and the equipment database 5, or a computer that includes the map information database 4 and the equipment database 5.

The map information database 4 and the equipment database 5 may be provided on a cloud server, a local server, or the like. In this case, the server 3 acquires the data stored in the map information database 4 and the equipment database 5 provided in the cloud server or the local server from the map information database 4 and the equipment database 5 via a communication network using a communication unit.

The data analysis function unit 3-1 performs, for example, a process of analyzing the point cloud data included in the measurement data from the measurement site terminal 2-1, quantitatively determining structural deterioration of the equipment including the deflection amount of the utility pole, and updating the equipment database 5.

The data analysis function unit 3-1 converts the point cloud data included in the measurement data transmitted from the measurement site terminal 2-1 to a three-dimensional object to generate three-dimensional model data, in order to calculate a deflection amount of the utility pole. Position coordinate data of three dimensions (X, Y, Z) is included in the three-dimensional model data. The data analysis function unit 3-1 calculates a deflection amount of the utility pole on the basis of the position coordinate data of the three dimensions (X, Y, Z).

Further, the data analysis function unit 3-1 may acquire equipment configuration information of the utility pole on the basis of the point cloud data included in the measurement data transmitted from the measurement site terminal 2-1, and update the equipment configuration information stored in the equipment database 5 on the basis of the acquired equipment configuration information. The equipment configuration information will be described below.

The equipment state diagnosis unit 3-2 diagnoses the equipment state of the utility pole on the basis of the equipment configuration information of the utility pole and the calculated deflection amount stored in the equipment database 5, and determines a diagnosis method. The equipment state diagnosis unit 3-2 generates a heat map including the determined diagnosis method, and transmits the display data for displaying the generated heat map to the user terminal 2-2.

The equipment state diagnosis unit 3-2 includes an equipment configuration pattern classification unit 3-2-1, a diagnosis method determination unit 3-2-2, and a heat map generation unit (a display control unit) 3-2-3.

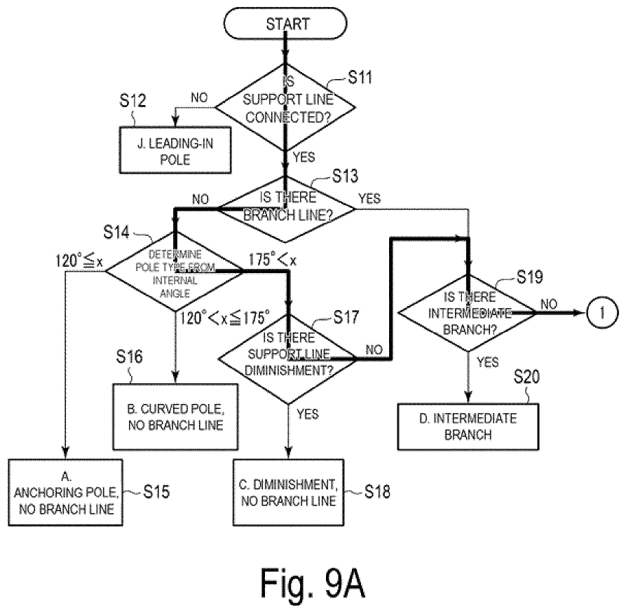

The equipment configuration pattern classification unit 3-2-1 classifies the equipment configuration of each utility pole into ten types of equipment configuration patterns (equipment configuration patterns A to J) by performing a process shown in a flowchart illustrated in FIGS. 8A and 8B to be described below, on the basis of the equipment configuration information stored in the equipment database 5.

The diagnosis method determination unit 3-2-2 determines the diagnosis method on the basis of the equipment configuration pattern classified by the equipment configuration pattern classification unit 3-2-1 and the deflection amount stored in the equipment database 5, of the utility pole corresponding to the equipment configuration patterns classified by the equipment configuration pattern classification unit 3-2-1.

The heat map generation unit 3-2-3 creates line information for connecting the respective utility pole on the basis of the equipment configuration information. The heat map generation unit 3-2-3 creates a heat map including the generated line information and including the diagnosis method for each utility pole determined by the diagnosis method determination unit 3-2-2. The heat map generation unit 3-2-3 creates the display data for displaying the generated heat map on a map indicated by the map information stored in the map information database 4, and transmits this display data to the user terminal 2-2.

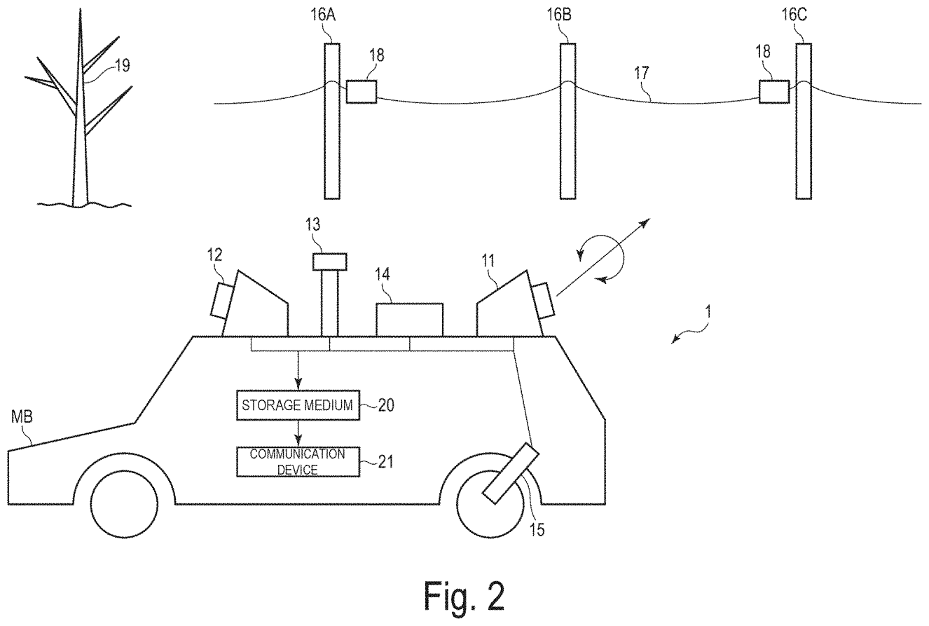

FIG. 2 is a diagram illustrating an example of the MMS 1 that acquires measurement data (point cloud data or image data).

This MMS 1 is mounted in an inspection vehicle MB, and includes a three-dimensional laser scanner 11 serving as a measurement unit, a camera 12 serving as an imaging unit, a Global Positioning System (GPS) receiver 13, an IMU 14 serving as an inertial measurement device, an odometer 15 serving as a travel distance meter, a storage medium 20, and a communication device 21.

The MMS 1 performs three-dimensional surveying of surroundings using the three-dimensional laser scanner 11, the camera 12, the GPS receiver 13, the IMU 14, and the odometer 15 during traveling of the inspection vehicle MB, and stores the data obtained by this surveying in the storage medium 20 serving as a point cloud data storage device.

The storage medium 20 is configured using, for example, a hard disk drive (HDD) or a solid state drive (SSD). Further, a camera in which an imaging direction is changed in any direction by a pan and tilt mechanism and an imaging range is changed through a zoom function is used as the camera 12.

The three-dimensional laser scanner 11 acquires position coordinate data of three dimensions (X, Y, Z) reflecting position coordinate data of a plurality of points on a surface of equipment (outdoor structures) such as utility poles 16A, 16B, and 16C, a cable 17, and a closure 18, or a natural object such as a tree 19, that is, position coordinates detected by the GPS receiver 13, while coordinating with position coordinates (latitude and longitude) calculated by the GPS receiver 13. The acquired three-dimensional position coordinate data is stored as point cloud data in the storage medium 20 in association with information indicating measurement time.

The camera 12 images an area including the outdoor structure or the natural object. Image data obtained by this imaging is stored in the storage medium 20 in association with an imaging time and the position coordinates detected by the GPS receiver 13. Acceleration data of the inspection vehicle MB output from the IMU 14 and travel distance data of the inspection vehicle MB output from the odometer 15 are also stored in the storage medium 20 in association with the measurement time and the position coordinates.

The GPS receiver 13 receives GPS signals transmitted from a plurality of GPS satellites (not illustrated) and calculates position coordinates (latitude and longitude) of the inspection vehicle MB on the basis of the GPS signals.

The communication device 21 transmits the measurement data stored in the storage medium 20 to the measurement site terminal 2-1. The measurement data includes point cloud data, image data, or the like.

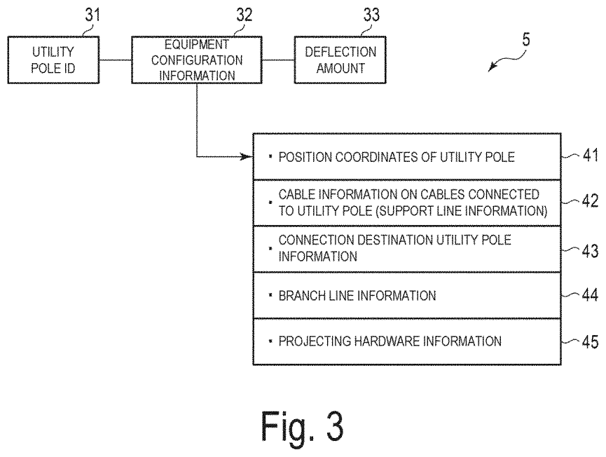

FIG. 3 is a diagram illustrating an example of equipment data that is stored in the equipment database 5.

As illustrated in FIG. 3, equipment configuration information 32 and a deflection amount 33 of a utility pole are stored in association with a utility pole ID 31 in the equipment database 5. For data stored in the equipment database 5, image data (not illustrated in FIG. 3) that is included in the measurement data from the MMS 1, for example, is also stored.

Further, the deflection amount indicates a distance between a point of a reference axis at a predetermined height (for example, 5 [m]) of the utility pole and a central axis of the utility pole. The reference axis is an approximate curve with respect to points (4 [m] increments) from a lowest point (x, y, 0) of the central axis of the utility pole to a height (for example, 2 [m]) of the central axis of the utility pole.

The equipment configuration information 32 includes position coordinates 41 of the utility pole, cable information 42 on cables connected to the utility pole, connection destination utility pole information 43, branch line information 44, and projecting hardware information 45. Although a value set by an equipment administrator in advance is used as the equipment configuration information 32 including these, the set value may be updated on the basis of the equipment configuration information obtained from the measurement data from the MMS 1.

The cable information 42 on cables connected to the utility pole (also referred to simply as cable information) is information indicating a type of cable (for example, an optical cable or a metal cable) that is connected to a utility pole that is a management target (also referred to simply as a target utility pole), and includes information on the presence or absence of a support line (a suspension line).

The connection destination utility pole information 43 is information on another utility pole that is connected to the target utility pole. The branch line information 44 is information indicating whether there is a branch line that is connected to the target utility pole. The projecting hardware information 45 is information indicating whether there is projecting hardware that is provided on the target utility pole.

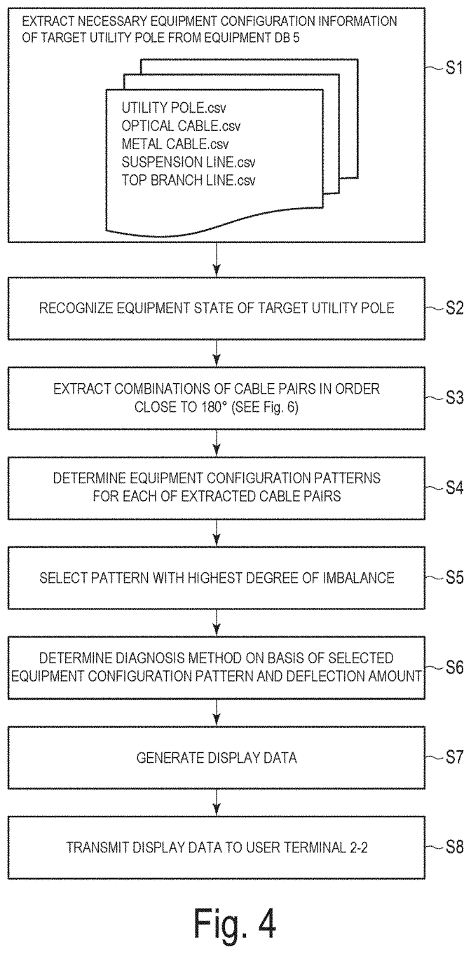

Next, an equipment state diagnosis method in the server 3 of the equipment state diagnosis system S according to the embodiment of the present invention will be described. FIG. 4 is a flowchart illustrating an example of an operation of the server 3 of the equipment state diagnosis system S.

The equipment state diagnosis unit 3-2 of the server 3 first extracts necessary equipment configuration information 32 (for example, a utility pole, an optical cable, a metal cable, a suspension line, and an upper branch line) of a target utility pole from the equipment database 5, as illustrated in FIG. 4 (S1). The equipment state diagnosis unit 3-2 then recognizes an equipment state of the target utility pole on the basis of the extracted equipment configuration information 32 (S2).

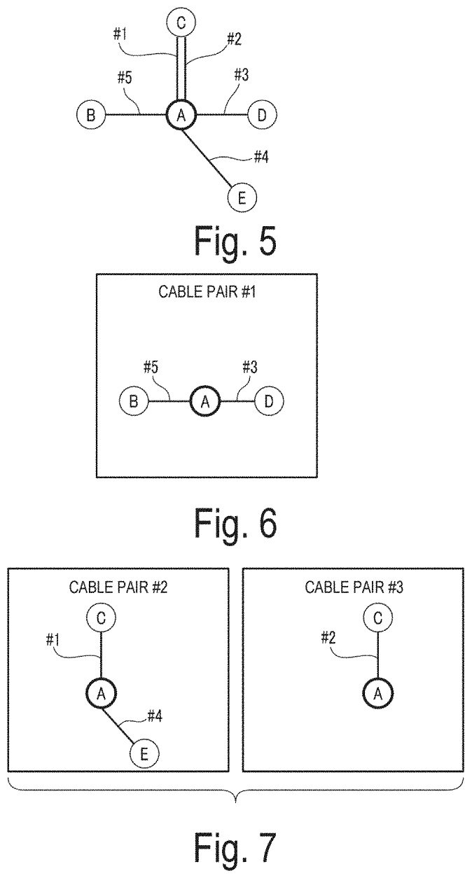

FIG. 5 is a diagram illustrating an example of an equipment state of a target utility pole A.

The target utility pole A is connected to a utility pole C by cables #1 and #2, connected to a utility pole D by a cable #3, connected to a utility pole E by a cable #4, and connected to a utility pole B by a cable #5, as illustrated in FIG. 5. This connected state is recognized from the cable information 42 on cables connected to the utility pole and the connection destination utility pole information 43 included in the equipment configuration information 32 associated with the utility pole ID 31 of the target utility pole A.

Further, directions of the respective cables #1 to #5 are recognized from the position coordinates 41 of the utility pole included in the equipment configuration information 32 related to the target utility pole A and the utility poles B, C, D, and E. Further, the presence or absence of a support line, a branch line, and a projecting hardware are recognized from the cable information 42, the branch line information 44, and the projecting hardware information 45 included in the equipment configuration information 32 of the target utility pole A. Here, it is assumed that the support line is “present”, the branch line is “absent”, and the projecting hardware is “absent” for the target utility pole A.

The equipment state diagnosis unit 3-2 then extracts a combination of pairs of cables (two cables) in order closer to 180° (S3).

Specifically, the equipment state diagnosis unit 3-2 extracts cable pairs in descending order of an internal angle (equal to or larger than 0° and equal to or smaller than 180°) of the cable pair from all combination of cable pairs (two cables) of the cables #1 to #5 (the intermediate branch cable is excluded). In this case, the equipment state diagnosis unit 3-2 searches for the next cable pair while excluding the extracted cable pair each time.

The internal angle is obtained by the position coordinates 41 of the utility pole included in the equipment configuration information 32 related to the target utility pole to which the cable of the cable pair is connected, and the position coordinates 41 of the connection destination utility pole indicated by the connection destination utility pole information 43 included in the equipment configuration information 32 related to a utility pole connected to the target utility pole to which the cable of the cable pair is connected.

When one cable remains and there is a cable pair passing through the same section as a section through which the cable passes, the equipment state diagnosis unit 3-2 includes the remaining cable in the cable pair and sets a diminishment flag. When there is no cable pair, the pole is determined to be an anchoring pole.

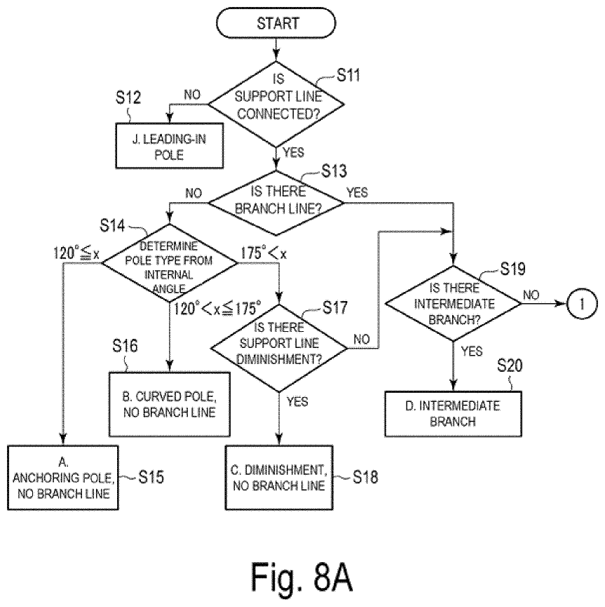

FIG. 6 is a diagram illustrating an example of a cable pair #1 of the target utility pole A.

As illustrated in FIG. 6, the cable pair #1 is a pair of cable #5 that connects the target utility pole A to the utility pole B, and a cable #3 that connects the target utility pole A to the utility pole D.

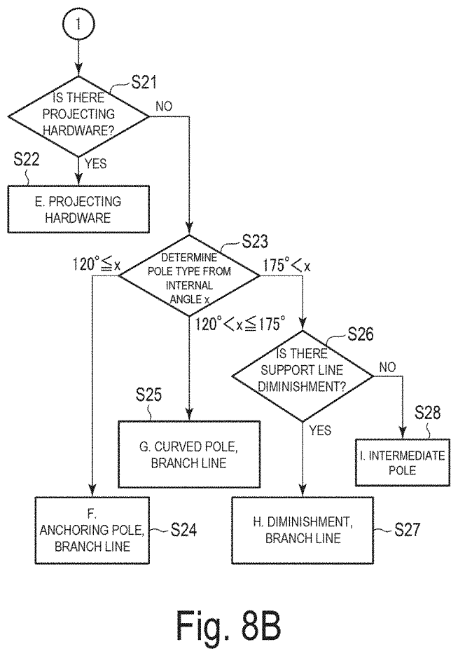

FIG. 7 is a diagram illustrating an example of cable pairs #2 and #3 of the target utility pole A.

As illustrated in FIG. 7, the cable pair #2 is a pair of cable #1 that connects the target utility pole A to the utility pole C, and a cable #4 that connects the target utility pole A to the utility pole E. The cable pair #3 is a cable #2 that connects the target utility pole A to the utility pole C. Here, because the cable pair #3 passes through the same section AC as a section through which the cable pair #2 passes, the equipment state diagnosis unit 3-2 includes the cable pair #3 in the cable pair #2 and sets a diminishment flag in the cable pair #2.

FIG. 4 is referred back to for description. In S3, the equipment state diagnosis unit 3-2 extracts the cable pair for the target utility pole and then performs a process of classifying (determining) equipment configuration patterns for each extracted cable pair (S4). A process of classifying the equipment configuration patterns will be described below. After the equipment configuration patterns are classified for each of the cable pair in S4, an equipment configuration pattern with a highest degree of imbalance is selected for the target utility pole (S5).

FIGS. 8A and 8B are flowcharts illustrating an example of operations for classifying equipment configuration patterns.

The classification of the equipment configuration pattern is performed for each of the cable pairs extracted for the target utility pole.

First, the equipment configuration pattern classification unit 3-2-1 determines whether a support line is connected to the target utility pole by referring to the cable information (support line information) included in the equipment configuration information 32 for the cable pair extracted for the target utility pole (S11).

When it is determined in S11 that the support line is not connected, the equipment configuration pattern classification unit 3-2-1 determines that the cable pair extracted for the target utility pole is a “leading-in pole” of the equipment configuration pattern J (S12).

On the other hand, when it is determined in S11 that the support line is connected, the equipment configuration pattern classification unit 3-2-1 determines whether a branch line is connected to the target utility pole by referring to the branch line information 44 of the equipment configuration information 32 for the cable pair extracted for the target utility pole (S13).

When it is determined in S13 that the branch line is not connected, the equipment configuration pattern classification unit 3-2-1 determines a pole type from the internal angle of the extracted cable pair by referring to the position coordinates 41 of the equipment configuration information 32 for the cable pair extracted for the target utility pole (S14).

Specifically, the equipment configuration pattern classification unit 3-2-1 determines the internal angle of the cable pair by referring to position coordinates 41 in the equipment configuration information 32 for the cable pair extracted for the target utility pole, and determines that the cable pair extracted for the target utility pole is “Anchoring pole, no branch line” of the equipment configuration pattern A when the internal angle x is equal to or smaller than 120° (S15).

When the internal angle x is greater than 120° and equal to or smaller than 175°, the equipment configuration pattern classification unit 3-2-1 determines that the cable pair extracted for the target utility pole is “Curved pole, no branch line” in the equipment configuration pattern B (S16). When the internal angle x is greater than 175°, the equipment configuration pattern classification unit 3-2-1 determines whether the diminishment flag is set for the cable pair extracted for the target utility pole (S17). That is, the equipment configuration pattern classification unit 3-2-1 determines whether there are other cable pairs passing through the same section as a section through which the cable in the cable pair extracted for the target utility pole passes.

When it is determined in S17 that the diminishment flag is set for the cable pair extracted for the target utility pole, the equipment configuration pattern classification unit 3-2-1 determines that the cable pair extracted for the target utility pole is “Diminishment, no branch line” of the equipment configuration pattern C (S18).

On the other hand, when it is determined in S13 that the branch line is connected or when it is determined in S17 that the diminishment flag is not set, the equipment configuration pattern classification unit 3-2-1 determines whether there is an intermediate branch for the cable pair extracted for the target utility pole (S19).

In the determination as to whether there is the intermediate branch in S19, when an actual cable length is longer than a horizontal distance, the equipment configuration pattern classification unit 3-2-1 determines that the extracted cable pair is the intermediate branch cable.

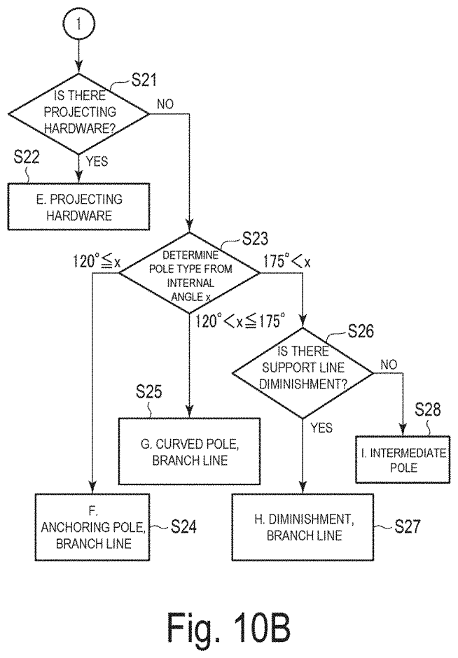

FIG. 11 is a diagram illustrating an example of a method of determining whether there is the intermediate branch.

In FIG. 11, for a cable pair (a cable between the target utility pole A and the utility pole B and a cable between the target utility pole A and the utility pole C), it is determined that there is an intermediate branch cable when the horizontal distance (c)<the actual length (a+b), and it is determined that there is no intermediate branch when the horizontal distance (c)≥the actual length (a+b).

Specifically, when a vertex X, which is a vertex of a triangle BCX, is present on a line segment AB, the target utility pole A and the utility pole B are determined to have an intermediate branch. A route r1 in FIG. 11 is an actual cable route (actual length) passing through the vertex X, and a route r2 in FIG. 11 is a cable route (horizontal distance) on an equipment DB. The triangle BCX is a triangle connecting the utility pole B, the vertex X, and the utility pole C, and the line segment AB is a line segment connecting the target utility pole A and the utility pole B.

When it is determined in S19 that there is the intermediate branch, the equipment configuration pattern classification unit 3-2-1 determines that the cable pair extracted for the target utility pole is an “intermediate branch” of the equipment configuration pattern D (S20).

When it is determined in S19 that there is no intermediate branch, the equipment configuration pattern classification unit 3-2-1 determines whether there is projecting hardware of the target utility pole by referring to the projecting hardware information 45 included in the equipment configuration information 32 related to the target utility pole (S21).

When it is determined in S21 that there is the projecting hardware of the target utility pole, the equipment configuration pattern classification unit 3-2-1 determines that the cable pair extracted for the target utility pole is the “projecting hardware” of the equipment configuration pattern E (S22).

When it is determined in S21 that there is no projecting hardware of the target utility pole, the equipment configuration pattern classification unit 3-2-1 determines a pole type on the basis of the internal angle x for the cable pair extracted for the target utility pole (S23).

When the internal angle x is equal to or smaller than 120° in S23, the equipment configuration pattern classification unit 3-2-1 determines that the cable pair extracted for the target utility pole is an “Anchoring pole, branch line” of the equipment configuration pattern F (S24).

When the internal angle x is greater than 120° and equal to or smaller than 175°, the equipment configuration pattern classification unit 3-2-1 determines that the cable pair extracted for the target utility pole is “Curved pole, branch line” of the equipment configuration pattern G (S25).

When the internal angle x is greater than 175°, the equipment configuration pattern classification unit 3-2-1 determines whether the diminishment flag is set for the cable pair extracted for the target utility pole (S26).

When the diminishment flag is set for the cable pair extracted for the target utility pole in S26, the equipment configuration pattern classification unit 3-2-1 determines that the cable pair extracted for the target utility pole is “Diminishment, branch line” of the equipment configuration pattern H (S27).

On the other hand, when the diminishment flag is not set for the cable pair extracted for the target utility pole, the equipment configuration pattern classification unit 3-2-1 determines that the cable pair extracted for the target utility pole is an “intermediate pole” of the equipment configuration pattern I (S28).

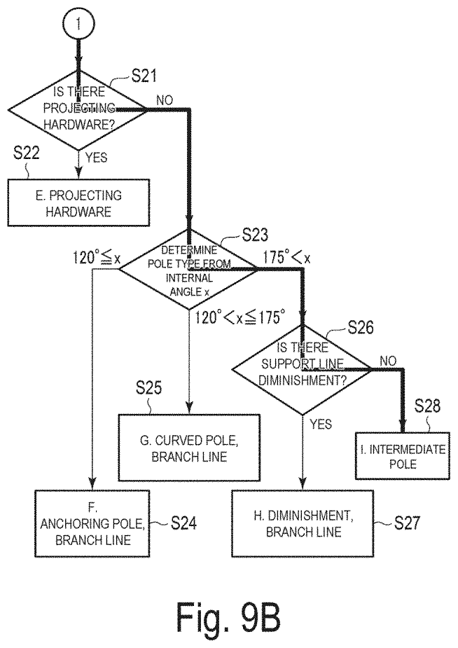

FIGS. 9A and 9B are diagrams illustrating a case in which the cable pair #1 illustrated in FIG. 6 is determined to be the equipment configuration pattern I (an intermediate pole).

Here, it is assumed that the cable information 42 included in the equipment configuration information 32 related to the target utility pole A indicates “support line”, the branch line information 44 indicates “no branch line”, and the projecting hardware information 45 indicates “no projecting hardware”, there is no intermediate branch and there is no diminishment. In this case, the equipment configuration pattern of the cable pair #1 is determined to be “intermediate pole” of the equipment configuration pattern I through S11, S13, S14, S17, S19, S21, S23, S26, and S28 as indicated by bold lines in FIGS. 9A and 9B.

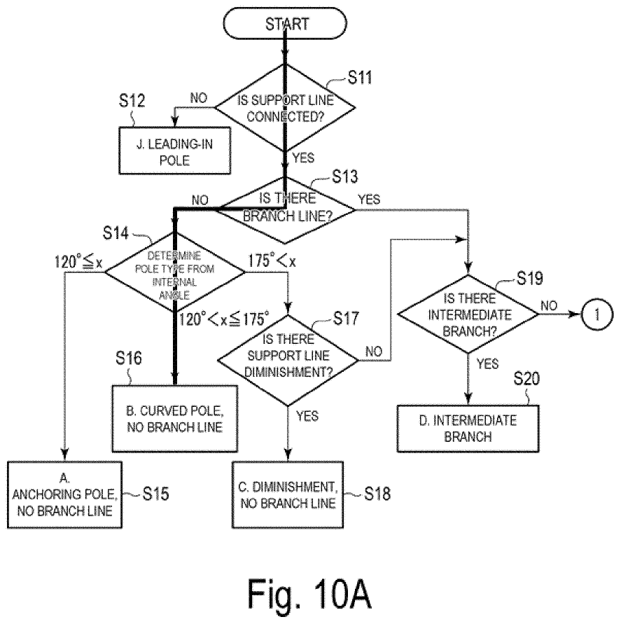

FIGS. 10A and 10B are diagrams illustrating a case in which the cable pair #2 illustrated in FIG. 7 is determined to be the equipment configuration pattern B.

Here, it is assumed that the cable information 42 included in the equipment configuration information 32 related to the target utility pole A indicates “Support line”, the branch line information 44 indicates “No branch line”, the projecting hardware information 45 indicates “No projecting hardware”, there is no intermediate branch, and there is diminishment. In this case, the equipment configuration pattern of the cable pair #2 is determined to be a “Curved pole, no branch line” of the equipment configuration pattern B through S11, S13, S14, and S16, as indicated by bold lines in FIGS. 10A and 10B.

Because the cable pair #3 passes through the same section AC as a section through which the cable pair #2 passes, the equipment configuration pattern classification unit 3-2-1 includes the cable pair #3 in the cable pair #2, and sets a diminishment flag in the cable pair #2.

FIG. 4 is referred back to for description. After the equipment configuration pattern having a highest degree of imbalance is selected in S5, the diagnosis method determination unit 3-2-2 determines a diagnosis method for the target utility pole on the basis of the selected equipment configuration pattern and the deflection amount of the target utility pole (S6).

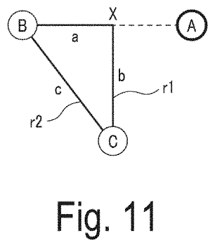

FIG. 12 is a diagram illustrating an example of a diagnosis scheme that is determined through quadrant classification. This determination of the diagnosis method is performed by the diagnosis method determination unit 3-2-2 illustrated in FIG. 3. For the determination of the diagnosis method, the diagnosis method determination unit 3-2-2 includes a diagnosis table in which the equipment configuration patterns A to J and the deflection amount are associated with diagnosis methods as illustrated in FIG. 12, the diagnosis method may be determined using the diagnosis table, or the diagnosis method may be determined using a program without using the diagnosis table.

As illustrated in FIG. 12, the degree of imbalance of the equipment configuration pattern A among the degrees of imbalance of the equipment configuration patterns A to J is highest, the degree of imbalance decreases in order from the equipment configuration pattern A to the equipment configuration pattern J, and the degree of imbalance of the equipment configuration pattern J is lowest.

In the equipment configuration patterns B and I determined above in the cable pairs #1, #2, and #3, the degree of imbalance in the equipment configuration pattern I<the degree of imbalance B in the equipment configuration pattern I, as illustrated in FIG. 12. Therefore, in S5 of FIG. 4, the equipment configuration pattern B is selected as the equipment configuration pattern with the highest degree of imbalance related to the utility pole A.

Further, the deflection amount 33 of the utility pole is stored for each of the utility poles in the equipment database 5. This deflection amount 33 indicates a distance between the point of the reference axis at a predetermined height (for example, 5 [m]) of the utility pole and the central axis of the utility pole, as described above.

As illustrated in FIG. 12, equipment states of the target utility pole are classified into quadrants according to the equipment configuration pattern and the deflection amount of the target utility pole, and an optimal diagnosis method is clearly specified for each of the quadrants.

That is, when the target utility pole is any one of the equipment configuration patterns A to E and the deflection amount is large, a diagnosis method of “Measures required” is determined for the target utility pole. When the target utility pole has any one of the equipment configuration patterns A to E and the deflection amount is small, a diagnosis method of “watch” indicating that there is concern that measures are required is determined.

When the target utility pole has any one of the equipment configuration patterns F to J and the deflection amount is large, a diagnosis method that investigation of causes is required and “Professional diagnosis is required”, that is, diagnosis by a professional being required is determined for the target utility pole. When the target utility pole has any one of the equipment configuration patterns F to J and the deflection amount is small, a diagnosis method of “safety” in which no measures are required is determined.

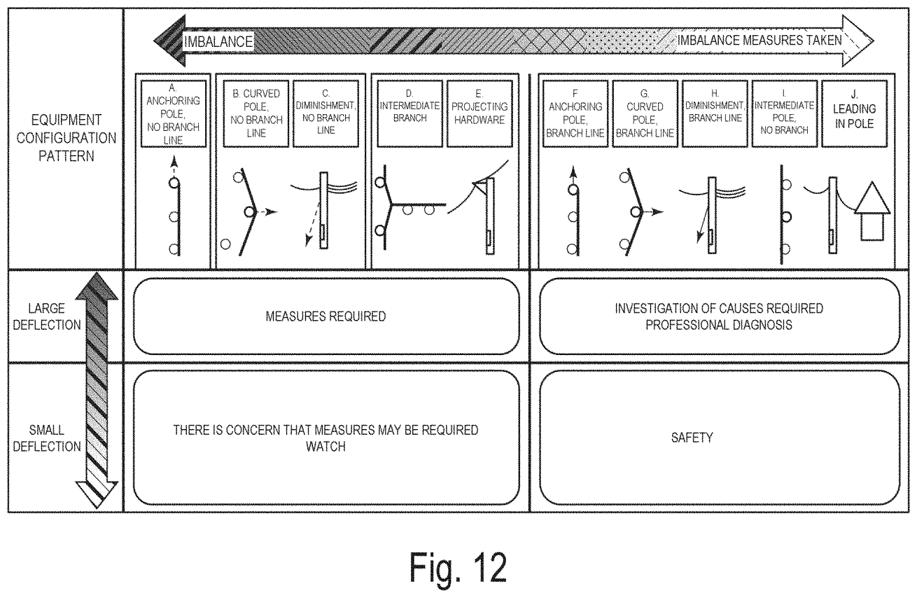

FIG. 13 is a diagram illustrating an example of a method of determining a quadrant score on the basis of the deflection amount and the degree of imbalance.

As described with reference to FIG. 12, the diagnosis method is determined on the basis of the deflection amount and the equipment configuration pattern. In this case, a score calculation unit included in the diagnosis method determination unit 3-2-2 determines a score of the diagnosis method. This score is obtained from the deflection amount and the equipment configuration pattern.

For the calculation of the score, for example, a point obtained by lowering a line perpendicular to a color bar of the determined diagnosis method from an intersection point between the equipment configuration pattern and the deflection amount determined by setting the equipment configuration pattern as a horizontal axis and the deflection amount as a vertical axis, as illustrated in FIG. 13, is the score.

In FIG. 13, a state in which a perpendicular line is lowered from an intersection point p determined from the equipment configuration pattern and the deflection amount to a color bar C2 in which the diagnosis method is “Professional diagnosis” is illustrated. Color bars C1, C2, C3, and C4 indicate lines from a center to four corners of a quadrant, respectively. The center of the quadrant is set as score “0” and the four corners of the quadrant are set as score “1”.

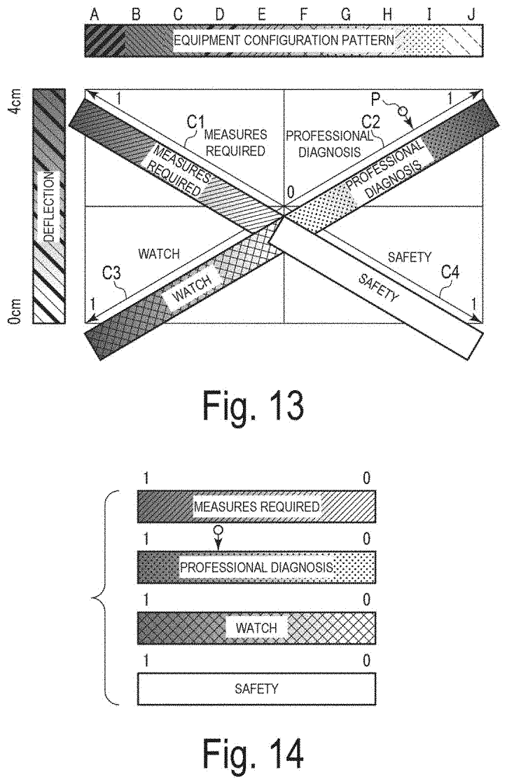

The score is used for a process of shading color according to a type of diagnosis method on a heat map to be described below. FIG. 14 is a diagram illustrating an example of a correspondence between a quadrant score and a color bar.

In the example illustrated in FIG. 14, when the diagnosis method is “Measures required”, for example, red color is used and darkened from score “0” to “1”. When the diagnosis method is “Professional diagnosis”, for example, yellow color is used and darkened from score “0” to “1”. When the diagnosis method is “watch”, for example, green color is used and darkened from score “0” to “1”. When the diagnosis method is “safe”, white is used. Thus, the diagnosis method determination unit 3-2-2 determines the diagnosis method for each of the utility poles, and determines a color and concentration thereof indicating the determined diagnosis method.

FIG. 4 is referred back to for description. After the diagnosis method has been determined in S6, the heat map generation unit 3-2-3 generates the display data for display on a screen of the user terminal 2-2 (S7), and transmits the generated display data to the user terminal 2-2 (S8).

Specifically, the heat map generation unit 3-2-3 generates display data including an image in which a circle with color and a concentration thereof of the determined diagnosis method, a utility pole, a line connecting the utility poles, and the like are displayed on a map and transmits the display data to the user terminal 2-2, such that the display data is displayed on the screen of the user terminal 2-2.

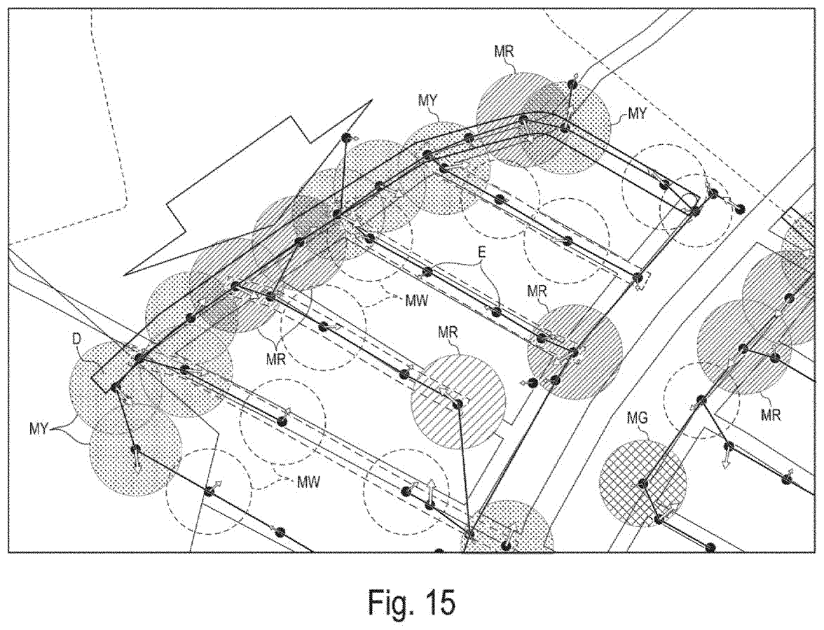

FIG. 15 is a diagram illustrating an example of a screen in which a heat map and line information to be displayed on the user terminal 2-2 are displayed on a map by the display data generated by the heat map generation unit 3-2-3.

As illustrated in FIG. 15, the line information for each of the utility poles E is displayed on the map, and an arrow is displayed on each of the utility poles E. A direction of the arrow indicates a slope of the central axis and a length of the arrow indicates the deflection amount. These pieces of information are obtained from the equipment configuration information 32 and the deflection amount 33 of the target utility pole.

Further, the heat map generation unit 3-2-3 displays circles in which the target utility poles are divided using color and concentration thereof, such that types of diagnosis methods and scores thereof are understood for the target utility poles for which the diagnosis method has been determined.

For example, in the case of a utility pole for which the determined diagnosis method is “Measures required”, the heat map generation unit 3-2-3 displays a red circle MR in association with the target utility pole. In the case of a utility pole for which the determined diagnosis method is “Professional diagnosis”, the heat map generation unit 3-2-3 displays a yellow circle MY in association with the target utility pole. In the case of a utility pole for which the determined diagnosis method is “watch”, the heat map generation unit 3-2-3 displays a green circle MG in association with the target utility pole. In the case of a utility pole for which the determined diagnosis method is “safe”, the heat map generation unit 3-2-3 displays a white circle MW in association with the target utility pole.

Thus, it is possible to ascertain a state of all lines rather than the utility pole alone by the heat map generation unit 3-2-3 drawing the line information (a connection between the utility pole and the cable), in addition to a heat map of quadrant information. For example, it can be seen that, for a portion D surrounded by a line in FIG. 15, a plurality of lines are drawn and the deflection increases in the entire line.

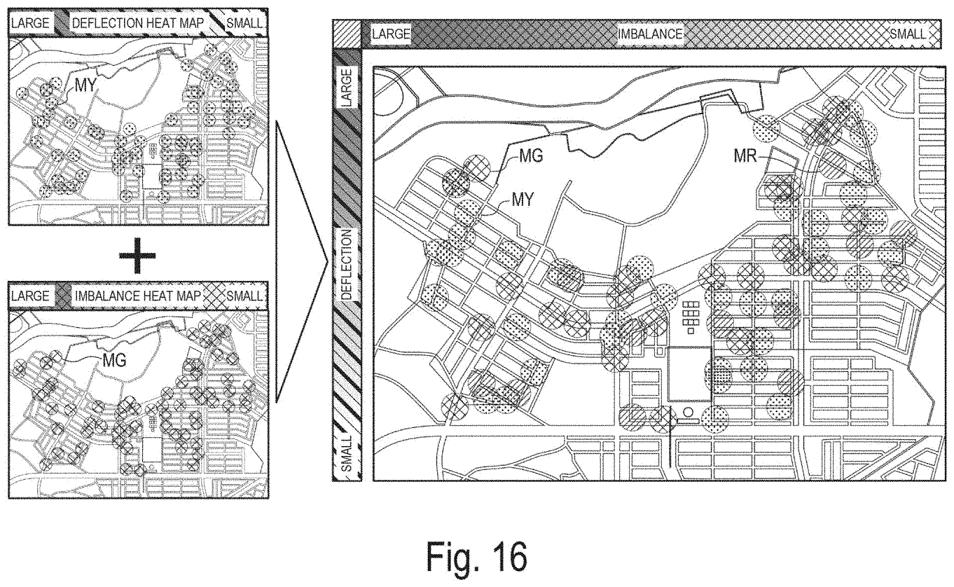

FIG. 16 is a diagram illustrating a modification example of a screen in which a deflection heat map and an imbalance heat map are displayed in a superimposed state on a map. The heat map generation unit 3-2-3 may create display data for the screen illustrated in FIG. 16 instead of the display data illustrated in FIG. 15.

In this case, the heat map generation unit 3-2-3 generates display data of a deflection heat map for displaying information according to a magnitude of the deflection amount of each of the utility poles, for example, displaying a yellow circle MY in association with the target utility pole on the map at a concentration according to the deflection amount. Further, the heat map generation unit 3-2-3 generates display data of an imbalance heat map for displaying information according to a magnitude of the degree of imbalance (equipment configuration pattern), for example, displaying a green circle MG in association with the target utility pole on the map at a concentration according to the equipment configuration pattern.

The heat map generation unit 3-2-3 superimposes display data of the deflection heat map with display data of the imbalance heat map to generate display data in which the deflection heat map and the imbalance heat map are displayed on the map. In this case, for a target utility pole having a large deflection amount and a high degree of imbalance, the heat map generation unit 3-2-3 displays, for example, display data in which the red circle MR is associated with the target utility pole.

Therefore, according to the embodiment of the present invention, it is possible to achieve equipment health by classifying the equipment states into quadrants and performing appropriate measures for each quadrant. For example, because there is concern that a utility pole that is not deflected, but is unbalanced with respect to the equipment configuration may be greatly deflected in the future, measures in which the utility pole is continuously watched are shown.

Further, because it is assumed that an unbalanced load is unexpectedly generated from the equipment configuration pattern in a utility pole that is balanced on the equipment configuration information, but deflected, measures in which a worker having specialized skills is dispatched to a site can be shown.

Further, work of classifying the equipment configuration patterns requires a large amount of operating time because a worker manually performs the classification while viewing local photographs and information of the equipment database 5 in the related art. On the other hand, according to the embodiment of the present invention, it is possible to greatly reduce an operating time by automatically determining the equipment configuration pattern on the basis of information in the equipment database 5.

In addition, it becomes possible for a worker to more easily visually recognize an area on which diagnosis is to be preferentially performed by mapping quadrant information onto the map as a heat map, and to ascertain an equipment situation of all lines affecting each other rather than a utility pole alone by drawing the line information (for example, a connection between a utility pole and cables) on the map together. Therefore, it is possible to take measures taking an optimal line state into account.

The present invention is not limited to the embodiments, and various modifications can be made without departing from the gist of the present invention in an implementing stage. Further, each of the embodiments may be embodied in combination as appropriate as possible, and in this case, combined effects can be obtained. Further, inventions in various stages are included in the above embodiments, and various inventions may be extracted by a combination selected from appropriate combinations of a plurality of configuration requirements to be disclosed. For example, in a case in which problems can be solved and effects can be obtained even when some configuration requirements are removed from all of configuration requirements shown in the embodiments, a configuration in which the configuration requirements have been removed can be extracted as an invention.

Further, a scheme described in each embodiment can be stored in a recording medium such as a magnetic disk (a Floppy (trade name) disk, a hard disk, or the like), an optical disc (a CD-ROM, a DVD, an MO, or the like), a semiconductor memory (a ROM, a RAM, a flash memory, or the like) or transferred by a communication medium for distribution, as a program (a software unit) that can be executed by a computing machine (a computer). The program stored in the medium also includes a setting program for causing a software unit (including not only an execution program but also a table or data structure), which will be executed in a computing machine, to be configured within the computing machine. A computing machine realizing the present device executes the above-described process by loading the program recorded on the recording medium or constructing a software unit using the setting program in some cases, and controlling an operation using the software unit. The recording medium referred to herein is not limited to a recording medium for distribution, and includes a storage medium such as a magnetic disk or a semiconductor memory provided inside the computing machine or in a device connected via a network.

### REFERENCE SIGNS LIST

1 MMS
2-1 Measurement site terminal
2-2 User terminal
3 Server
3-1 Data analysis function unit
3-2 Equipment state diagnosis unit
3-2-1 Equipment configuration pattern classification unit
3-2-2 Diagnosis method determination unit
3-2-3 Heat map generation unit
4 Map information database
5 Equipment database
31 Utility pole ID
32 Equipment configuration information
33 Deflection amount
41 Position coordinates of utility pole
42 Cable information
43 Connection destination utility pole information
44 Branch line information
45 Projecting hardware information

1. An equipment state diagnosis device comprising:
a processor; and
a storage medium having computer program instructions stored thereon, when executed by the processor, perform to:
classify an equipment state of a utility pole into an equipment configuration pattern based on equipment configuration information of the utility pole obtained from a database in which the equipment configuration information and a deflection amount of the utility pole are stored; and
determine a diagnosis method for the utility pole from the equipment configuration pattern of the utility pole classified and the deflection amount of the utility pole obtained from the database.

2. The equipment state diagnosis device according to claim 1, wherein the computer program instructions further perform to generate display data for causing a terminal to display the diagnosis method for the utility pole determined.

3. The display device according to claim 2, wherein the display data is data for causing the diagnosis method for the utility pole to be displayed on a map.

4. The equipment state diagnosis device according to claim 3, wherein the computer program instructions further perform to
calculate a score of the diagnosis method, and
the display data generated is data for causing the diagnosis method for the utility pole to be displayed on a map in a display aspect according to the score.

5. The equipment state diagnosis device according to claim 2, wherein the display data is data for causing line information on a line between utility poles to be displayed on a map based on the equipment configuration information.

6. The equipment state diagnosis device according to claim 1,
wherein the equipment configuration information comprises position coordinates, support line information, connection destination utility pole information, branch line information, and projecting hardware information of the utility pole, and
the computer program instructions further perform to classify the equipment configuration patterns of the utility pole based on the position coordinates, the support line information, the connection destination utility pole information, the branch line information, and the projecting hardware information of the utility pole.

7. An equipment state diagnosis method comprising:
classifying an equipment states of a utility pole into an equipment configuration pattern based on equipment configuration information of the utility pole obtained from a database in which the equipment configuration information and a deflection amount of the utility pole are stored; and
determining a diagnosis method for the utility pole from the equipment configuration pattern classified of the utility pole and the deflection amount of the utility pole obtained from the database.

8. (canceled)

9. An equipment state display method comprising:
classifying an equipment state of a utility pole into an equipment configuration pattern based on equipment configuration information of the utility pole, and receiving display data comprising a diagnosis method for the utility pole diagnosed from the classified equipment configuration patterns of the utility pole and a deflection amount of the utility pole, and another diagnosis method for another utility pole; and
displaying the received display data, the diagnosis method for the utility pole and the another diagnosis method for the another utility pole on a map as visualization graphs divided for each of the diagnosis method and the another diagnosis method together with line information of the utility pole and the another utility pole.
